(19) United States
(12) Patent Application Publication
(10) Pub. No.: US 2011/0202470 A1
(43) Pub. Date: Aug. 18, 2011

(54) SYSTEM AND METHOD FOR OBLIGATION MANAGEMENT

(75) Inventors: AJAY AGRAWAL, NEW DELHI (IN); KANTI PRABHA, GURGAON (IN); ADITYA GUPTA, GURGAON (IN)

(73) Assignee: UNITEDLEX CORPORATION, OVERLAND PARK, KS (US)

(21) Appl. No.: 12/902,040

(22) Filed: Oct. 11, 2010

(30) Foreign Application Priority Data
Feb. 17, 2010 (IN) 343/DEL/2010

(51) Int. Cl. G06Q 10/00

(52) U.S. Cl. 705/301

(57) ABSTRACT

A system and methods for managing obligations. The system includes a database storage system including at least one contract, wherein a contract including a plurality of obligations. A data processing system, operatively coupled to the database storage system, manages the contracts and the obligations. The data processing system is configured to extract the plurality of obligations associated with the contract, and define relationships between these obligations. Upon computation of the defined relationships, the data processing system triggers corresponding actions, resulting in obligation compliance.

### TECHNICAL FIELD

The present application relates generally to the field of contracts and obligations, and more particularly to management of contracts and obligation compliance.

### BACKGROUND

To maintain a competitive edge in the global market, modern commercial organizations enter into numerous contracts and agreements with other organizations, to govern their relationships. A contract or agreement often defines rights and obligations of the contracting parties. Each of these rights and obligations requires the parties to perform some action or ensure compliance to a set of instructions.

As these contracts typically require the contracting parties to perform a multitude of actions, ranging from delivering projects according to set deadlines, maintaining confidentiality, quality assurance, and so on, they can be quite complex in nature. Some contracts may persist for many years, requiring the parties to repeat the requisite actions for several years. Moreover, an organization may have entered into a number of contracts with multiple organizations, resulting in performing thousands of actions related to those contracts. Non-compliance with any single obligation stated in a contractual document may result in revenue issues and legal implications.

To overcome such issues, contracting parties ensure management of their contracts. Contract management includes, but is not limited to, identifying the actions required by parties to a contract, identifying due dates, providing timely notifications to responsible individuals and apprising them of appropriate actions to be performed, and so on. In complex arrangements, however, managing contracts may be laborious and time consuming, detrimentally affecting economy and efficiency of an organization. Further, most contracts or obligations are related to one another and an action performed on one obligation may trigger related obligations, requiring a set of inter-related events to be performed. As a result, it is important to understand each obligation and its corresponding relationships.

Currently, automated systems for contract management have not been widely used, and managing such contracts has largely been a manual task where the efficiency of the contract management system is largely dependent upon the skill of the contract manager. Additionally, no solution exists that can help manage relationships between contracts and obligations, ensuring complete conformity.

Accordingly, there exists a need for an automated system that manages contracts and obligations throughout their life cycles, ensuring effective and timely compliance.

### SUMMARY

The present disclosure provides an obligation management system for ensuring obligation compliance. The obligation management system includes a databases storage system including at least one contract; a contract includes a plurality of obligations. A data processing system, operatively coupled to the database storage system, is configured to extract the contract and the plurality of obligations from the database storage system, and define relationships between the plurality of obligations. Each obligation is associated with a set of parameters, and the relationships are defined on these sets of parameters. Further, the data processing system is configured to compute the relations and trigger actions based on the results of the computations. These triggered actions ensure obligation compliance.

Another disclosed embodiment is a method for automating obligation compliance management. The method includes receiving a set of contracts, a plurality of corresponding obligations and metadata associated with each contract and obligation. These contracts and the corresponding obligations are assembled in a hierarchical structure, using the associated metadata. Further, the method includes assigning a set of parameters to each contract and obligation from the set of contracts and the obligations and defining relationships between the contracts and the obligations, using the set of parameters. Once the value of at least one parameter from the set of parameter associated with a contract or obligation is modified, the method includes computing the defined relationships, resulting in triggering related actions.

### BRIEF DESCRIPTION OF THE DRAWINGS

The drawing figures described below set out and illustrate a number of exemplary embodiments of the disclosure. Throughout the drawings, like reference numerals refer to identical or functionally similar elements. The drawings are illustrative in nature and are not drawn to scale.

FIG. 1 is an exemplary embodiment of a contracts and obligation management according to the present disclosure.

FIG. 2 is an exemplary embodiment of an obligation management system providing an automatic means for managing obligations.

FIG. 3 is a flowchart illustrating an exemplary method for automatically managing contracts and obligations.

FIG. 4 is an exemplary screenshot of an obligation management system.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### Overview

The present disclosure describes a method and system for managing contracts and obligations associated with an organization or a group or organizations. The obligation management system provides an analytical model to manage timely compliance of obligations or contracts. On an organizational level, the system includes assembling contracts and obligations associated with an organization into a hierarchical structure and defining relationships between these contracts and obligations. The present disclosure provides a user friendly, convenient means to analyze contracts. Typically, obligation compliance is dependent on the status of multiple dependent obligations. The system ensures defining associations of a contract or an obligation with all required dependents. Once the status of an obligation or contract changes, the defined relationships ensure status modifications of related contracts and obligations. Consequently, requisite actions associated with contracts and obligations are triggered, depending on their current statuses. The triggered actions ensure timely and effective completion of each obligation. As a result, the present disclosure provides an automated process to manage contracts, with minimum human intervention.

### Exemplary Embodiment

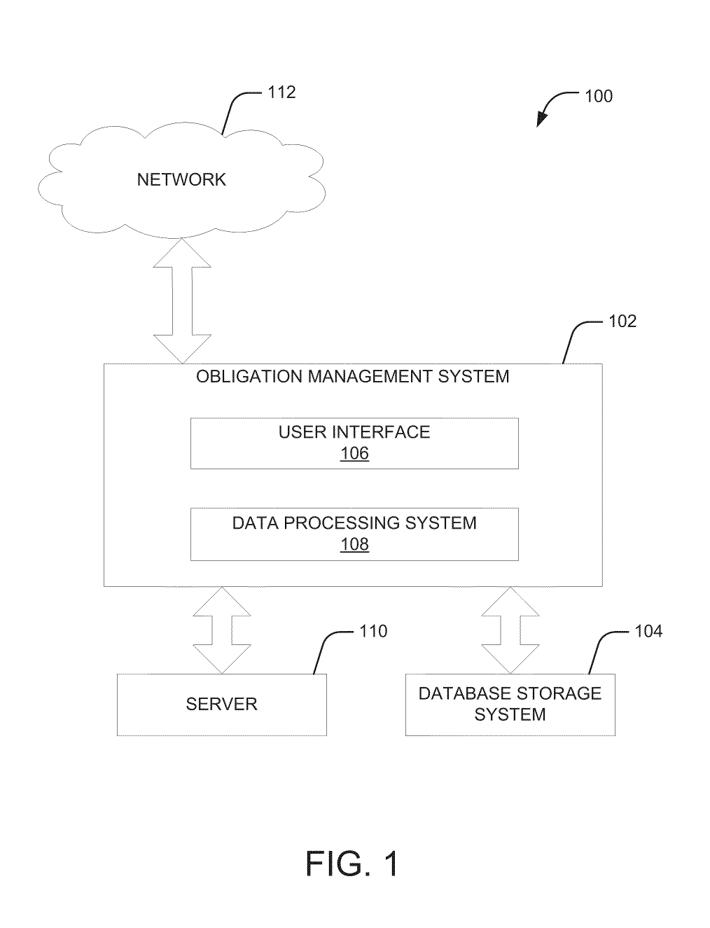

FIG. 1 illustrates system 100 within which the teachings of the present disclosure may operate. The environment 100 depicts an obligation management system 102 coupled to a database storage system 104. The obligation management system 102 and the database storage system 104 may be present on a computing device such as a computer, laptop, notepad, mobile device, or other handheld device known to those in the art.

Typically, a database storage system includes a number of documents, including contractual documents associated with an organization or a group of organizations. It should be understood that a single database storage system 104 is shown for purposes of simplicity, but those skilled in the art will appreciate that a real time system can include a number of database storage systems. It will be understood that the term “database,” in the present context, denotes any type of persistent storage, such as, for example, a relational database, a hierarchical database, an object oriented database, or a file system.

Contractual documents refer to legal agreements signed between parties specifying obligations to be completed by contracting parties. The effectiveness of a contract is typically determined by two factors—time and percentage compliance. Conventionally, status of a contract or an obligation identifies the current state of the contract or obligation in terms of time and compliance, providing information about its effectiveness. Status of an obligation or contract may be complete, in-progress, overdue, percentage complete, and so on. As already discussed, with large organization including several agreements with a number of organizations, managing effective closure of each obligation is a complex task.

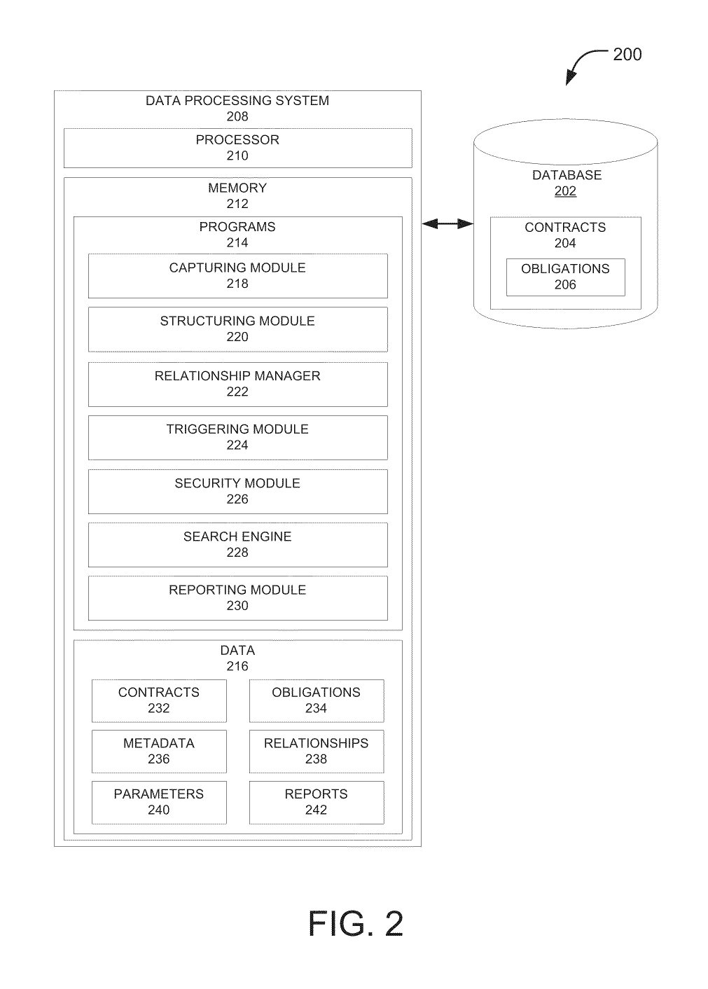

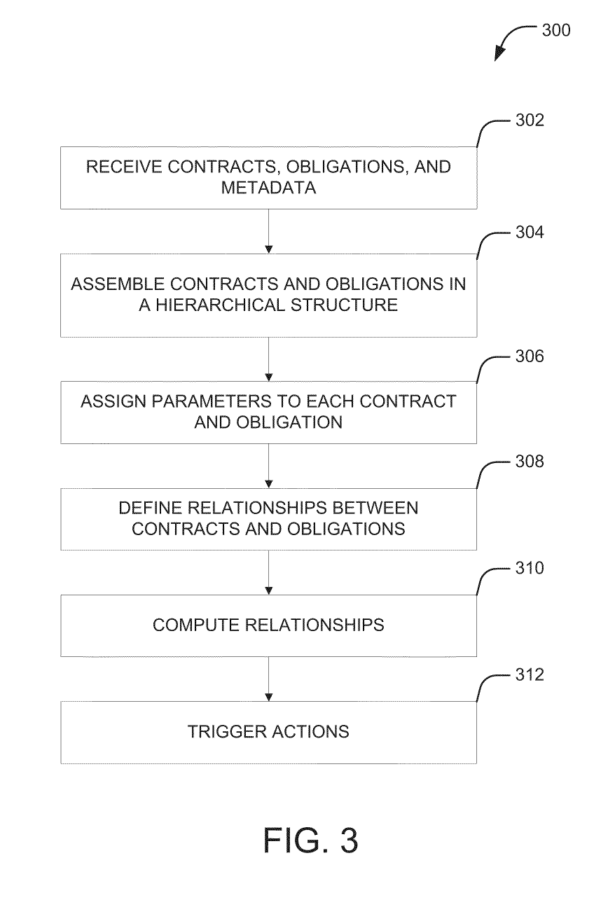

To overcome this issue, the present disclosure employs the obligation management system 102, including a user interface 106 and a data processing system 108. The data processing system 108 operates on the contractual documents stored in the database storage system 104 to ensure effective and timely compliance of obligations. The data processing system 108 provides capabilities of analyzing contracts, defining relationship between contracts and obligations, organizing contracts and obligations in a hierarchical structure, tracking status of obligations, triggering actions based on status of an obligation. Moreover, managing amendments to contracts, ensuring correct and timely compliance of obligations, searching contract documents, maintaining confidentiality and security, providing web access, generating reports, and other contract managing tasks required throughout the life cycle of contracts and obligations are other capabilities rendered by the processing system 108. The functionalities of the processing system 108 are described in detail in the following sections in connection with FIGS. 2 and 3.

The user interface 106 allows users to analyze contracts and obligations. Among other capabilities, the user interface 106 provides a means for a user to modify the status of an obligation, view reports depicting statuses of contracts and obligations, receive notifications, view contracts and obligations, and so on. The user interface 106 may be fully customizable based on a user's preference or requirements. The data processing system 108 may includes scripts, or programs developed on Java, .NET, or other developing software known to those skilled in the art.

The environment 100 also includes a server 110, which provides a means to execute the functionalities of the obligation management system 102. In one implementation, when a user is an individual, the user's computing device may be the server 110, and the system 102 may be deployed on the computing device. In other implementations, however, a user may be an employ or associated with an organization; in such situations, the environment 100 may be an organizational network, including thousands of computing devices spread throughout several countries or locations. The system 102 may be deployed on one or more servers, such as the server 110, to which the employee's computing devices are connected. Alternately, in another possible implementation, the environment 100 can include a small sized organization with a few users.

Further, the environment 100 illustrates a network 112, operatively coupled to the obligation management system 102. In an embodiment of the environment 100, the network 112 may be the Internet, allowing web access to users from any geographical location. The network 112 can also provide functionalities of coupling the system 102 with a user's email. In another embodiment of the environment 100, the network 112 may be an organization's private network, connecting the employees of the organization. Further, the system 102 is compatible with a number of operating systems, and software. For example, the system 102 may be coupled with mail clients such as MS Outlook™, Lotus Notes™, etc., enabling easy status modifications, and receiving reminders or alerts as calendar items.

### Detailed Exemplary Embodiments

FIG. 2 illustrates an exemplary embodiment of an obligation management system 200, illustrating various modules and functionalities. The system 200 may operate on the exemplary environment 100 depicted in FIG. 1; however, those skilled in the art will appreciate that other environments for implementing the system 200 can be anticipated.

The system 200 includes a database 202, including multiple contracts 204, each contract including a number of obligations, such as obligations 206. Obligations belonging to multiple contracts are collectively referred to as obligations 206 in the present disclosure, for purposes of description. Typically, in a large organizational environment, the database 202 may include a large number of contracts 204 and obligations 206, often running into the thousands. To manage these contracts and obligations, the system 200 includes a data processing system 208 operatively coupled to the database 202.

The data processing system 208, which further includes a processor 210 and a memory 212, processes the contracts 204 and the obligations 206. The processor 210 can include one or more microprocessors, microcomputers, microcontrollers, digital signal processors, central processing units, state machines, logic circuitries, or any devices that manipulate commands or signals based on operational instructions. Among other capabilities, the processor 210 fetches and executes computer-readable instructions stored in the memory 212. The memory 212 can include any computer-readable medium known in the art including, for example, volatile memory such as a random access memory, or non-volatile memory such as flash memory. As illustrated in FIG. 2, the memory 212 further includes programs 214, and data 216.

The basic functionalities of the obligation management system 200 include: capturing all contracts and obligations, defining relationships between these contracts and obligations, computing these relationships, and triggering appropriate actions based on the computations to ensure compliance. To this end, the programs 214 include modules such as a capturing module 218, a structuring module 220, a relationship manager 222, a triggering module 224, a security module 226, a search engine 228, and a reporting module 230. The functionalities of these modules are set out in the following sections.

The capturing module 218 extracts the contracts 204 and the obligations 206 stored in the database 202. Typically, contracts 204 are stored in the database 202 as scanned, non-readable, or non-editable copies, which may not be processed by the data processing system 208. Consequently, the system 200 extracts the contracts 204, with the obligations 206, into a structured format, which is editable and readable, such as Microsoft Excel™ or Word™. The extracted contracts 204 and obligations 206 are stored in the memory 212, such as contracts 232, and obligations 234, with a unique identifier to provide easy access. In an embodiment of the system 200, the contracts 204 and obligations 206 may be stored in the database 202 in a structured form, instead of the memory 212.

Apart from the contractual information, the capturing module 218 also extracts metadata 236, associated with the contracts 204 and obligations 206, which may be stored in the memory 212. For example, name, summary, type, associated department, contracting party, owner, due date, frequency, end date, and other known relevant metadata describing a contract or obligation. Metadata provides a means to classify the obligations 206 and contracts 204. In an embodiment of the system 200, users may capture the metadata 236 manually. In another embodiment, however, an algorithm may automatically extract metadata associated with the contracts 204 and obligations 206.

Once the relevant contracts 204 and obligations 206 are extracted and appropriate identifiers are allocated, the structuring module 220 assembles them in a hierarchical structure, such as tree structure. The structuring module 220 uses metadata, such as the metadata 236, associated with the contracts and obligations to determine their relationships and dependency. For example, a relationship of an organization with a third party is defined as an account, with a unique account number, and can be represented in a tree structure, with global level contracts being on top of the tree, followed by Master Agreements, sub-agreements, Statement-of-work (SOW), and other annexure, exhibits, or addendums. A user may view all contract and obligation associated with an account in a tree form, making the system 200 user-friendly and comprehensible.

As already discussed, contracts are typically complex in nature and dependent on each other. Conventionally, current state of an obligation is interpreted manually by analyzing hundreds and thousands of documents, which is cumbersome and human errors may result in an incorrect value. To overcome such issues, the relationship manager 222 defines relationships between the contracts 232 and the obligations 234. The relationships, stored in the memory 212 such as relationships 238, include algorithms defining the dependency and relationship between the contracts 232 and the obligations 234. These algorithms or relationships generate an analytical model that provides appropriate status of an obligation at any point of time. The relationships 238 are defined using complex algorithms including mathematical operators such as, not limited to, unary operators, binary operators, ternary operators, Boolean operators, relational operators, logical operators, and so on. In an implementation of the system 200, the relationship manager 222 may also divide an obligation into multiple sub-obligations to capture appropriate relationships between obligations or sub-obligations.

To this end, the relationship manager 222 assigns a set of parameters 240, to each contract and obligation, describing current state of the corresponding obligation or contract. The parameters 240 assigned to a contract or an obligation may vary. The set of parameters 240 associated with an obligation include, but not limited to, current status, reoccurrence frequency, due date, time zone, and other parameters describing the current state of a an obligation. Current status, which may be modified by an authorized user or the system 200, may indicate complete, in-progress, overdue, percentage complete, or other status parameters. Time zone refers to a parameter defining the time zone according to which an obligation needs to be completed. In case of contracts, the associated parameters 240 may include some additional factors, such as contract value, complexity, criticality, and so on. In certain situations, the relationship manager 222 may also assign a particular weightage parameter to the contracts or obligations, based on their criticality, and these weightages may be utilized to define relationships. The compliance of an obligation may be computed based on the weightage assigned to it. For example, an obligation, with weightage 2%, may be treated as complete while calculating the overall compliance of the corresponding contract, even with only 80% completion.

The relationship manager 222 uses the parameters 240 associated with the contracts 232 and the obligations 234 to generate the relationships 238. For example, a statement of work for a project includes a number of obligations including a—sending emails on completion of a project, b—completing project on time, c—uploading project deliverables on a webpage; a, b, and c being status parameters associated with the three obligations. It should be apparent that obligation b will not be completed until a and c are closed. The relationship manager 222 captures such relationships using algorithms, such as b=a+c. For purposes of description, a simple mathematic expression is employed to show relationships between obligations; however, those skilled in the art will appreciate that complex contracts are related through complex algorithms. Further, a number of such simple or complex algorithms may be combined to define relationships with other obligations or contracts. For example, 1=((a+b+c) AND (c+e)) NOT (f), where a, b, c, e, f, and 1 are parameters, such as the parameters 240, associated with a group of obligations. A user, in certain situations, may be allowed to view these relationships 238, providing a means to analyze contracts.

The relationship manager 222 may define relationships 238 once the contracts 232 and the obligations 234 are captured, and store the relationships 238 in the memory 212. The system 200, however, renders capabilities of modifying the relationships 238 at any point of time by an authorized user. Further, any amendment, including modification, deletion, or addition, to a contract document is addressed by the system 200. The relationship manager 222 modifies the existing algorithms or appends algorithms based on the amendments.

As a result, the relationship manager 222 converts complex data including contracts and obligations into an analytical model with easy to implement and interpret equations or relationships.

The processor 210 computes the relationships 238 to update the current state of the obligations and contracts. Based on a determination that the value of a parameter, from the parameters 240, associated with an obligation changes, the processor 210 ensures execution of all relationships associated with the obligation. As discussed, the obligations 234 and the contracts 232 are related to each other, and the processor 210 ensures that the current state of an obligation and a contract is in accordance with the state of related obligations or contracts. The computation of the relationships 238 results in status change of associated obligations or contracts.

The most important function of the system 200 is to ensure timely and correct completion of an obligation. To this end, the triggering module 224 activates appropriate actions based on the current state of an obligation, resulting in obligation compliance. The triggering module 224 monitors the value of the parameters 240 associated with the contracts 232 and the obligations 234 for automatically triggering corresponding actions. For example, if status of an obligation specifies “in-progress” and the due date is within the next two days, the triggering module 224 may send a reminder or an alert to the concerned user in time, requesting for completion of the obligation. Upon receiving no inputs from the informed user within the stipulated time, the triggering module 224 may escalate the matter to another user higher up in the hierarchy and may modify the status to overdue. Sending reminders, notifications, alerts, e-mails, escalations, status change requests; status modification; generating reports; creating dashboards, or other known actions related to obligation management are some of the actions triggered by the triggering module 224. It should be understood to those skilled in the art that the triggering module 224 may activate any known action required from a user for obligation closure or conformity.

Among other capabilities, the system 200 also provides security features to organization's legal documents, using the security module 226, which may enhance security by allowing access to only authorized users. In an implementation, the security module 226 may conduct user authorization and verification by setting user accounts, and providing users with personal usernames and passwords. Further, a user may be provided with access to only a set of contracts or obligations, ensuring confidentiality. An employee monitoring contracts and obligations associated with a third party may not be assigned access to contracts and obligation corresponding to another contracting party, for example. Moreover, a user may be assigned different types of access rights to an obligation or contract, such as read, write, or modify rights. A user assigned modification rights to an obligation, can modify the parameters 240, such as current status associated with the obligation.

Conventionally, contractual documents are non-editable, scanned documents stored in an organizational database. The only way to analyze these documents is to read hundreds and thousands of pages manually, wasting time and resource. To overcome this issue, the system 200 provides the search engine 228 capable of searching contracts 232 and obligations 234 using keywords and metadata. For example, the system 200 allows searching for a contract associated with a particular organization, searching for an obligation with a particular keyword, searching for all contracts related to a business unit, and so. Further, the search engine 228 allows clustering techniques to provide more effective search results. The clustering techniques are known to those skilled in the art and are not explained in detail here.

To analyze the contractual status of an organization, an account, a contract, an obligation, or a business unit, the system 200 provides a means to generate reports or dashboards. The reporting module 230 generates such reports based on user's requirements. Typically, reports produced by the reporting module 230 can be in the form of data or graphs, providing an insight to current situations, trends, successes, failures, and so on. These reports may also be stored in the memory 212, such as reports 242, for future reference. The reporting module 230 allows users to represent data in any desired format. Further, the system 200 allows downloading or saving a copy of the reports 242 on a personal machine or memory device.

As a result, system 200 provides an automated system to manage contracts and obligations. The system 200 converts data included in contracts and obligations into an analytical model for capturing the dependency and relationships between contracts and obligations. The computation of the analytical model ensures updating the current state of contracts and obligations. Based on the current status of a contract or an obligation, the system 200 apprises users of all obligations that need attention on time, resulting in effective completion and promoting an organizational economy.

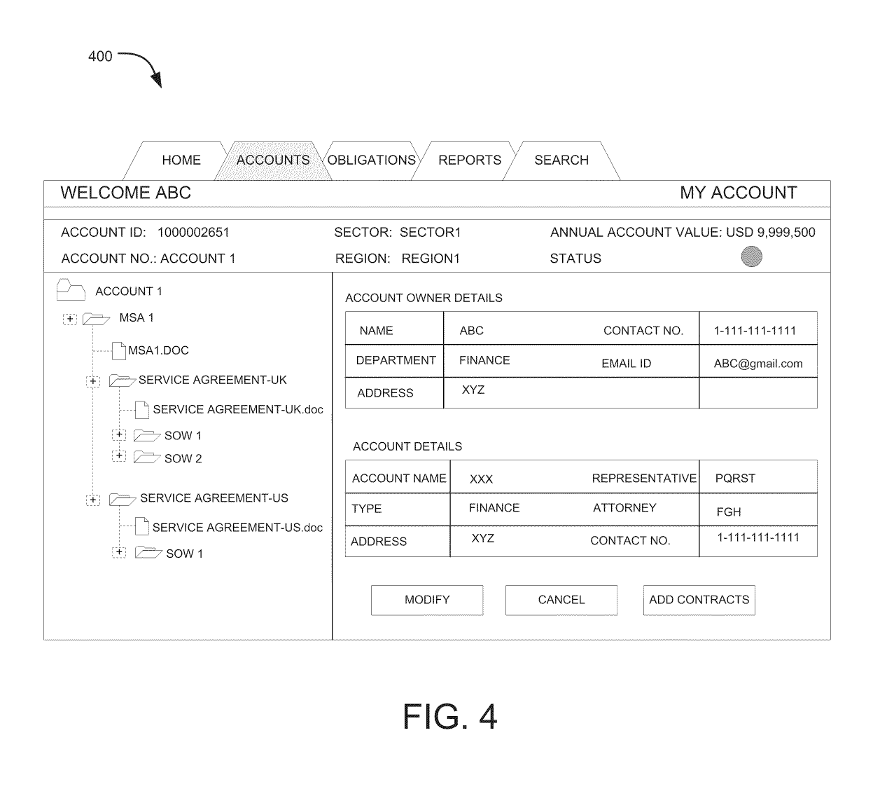

To demonstrate the applications of the present disclosure, an exemplary snapshot of the obligation management system 200 is illustrated in the following section in connection FIG. 4.

FIG. 3 outlines a method for carrying out the subject matter of the disclosure. The method 300 includes steps 302 to 312 describing a method for automatically managing contracts and obligations, with minimal or no human intervention. The system 200 provides a suitable environment to implement the method 300, however, those skilled in the art will appreciate that other environments, or systems may be anticipated for implementation of the method 300.

The method 300 starts at step 302, where, the method includes receiving contracts, obligations, and associated metadata, such as the contracts 204, the obligations 206, and the metadata 236. At step 302, the method 300 stores extracted contracts and obligations in the memory 212, such as the contracts 232 and the obligations 234. A user may manually input the metadata 236 into the memory 212. In other situations, the system 200 may employ a plug-in device for automatically capturing the metadata 236 associated with the contracts 204 and the obligations 206.

At step 304, based on the metadata 236, the method 300 assembles the contracts 232 and the obligations 234 in a hierarchical structure, providing a feature to understand the correlation, as discussed in connection with the structuring module 220. Next, at step 306, a set of parameters, such as the parameters 240, are assigned to the contracts or obligations. The set of parameters identify the current state of an obligation.

At step 308, the method 300 defines relationships between the contracts 232 and the obligations 234, using the relationship manager 222. As described in FIG. 2, the relationship manager 222 uses the parameters 240 to define the relationships 238, which captures the dependencies between the contracts 232 and the obligations 234. Further, the method 300 includes computing the relationships 238, at step 310, which assist updating the statuses of the contracts 204 and obligations 206.

Finally, at step 312, the method 300 triggers actions corresponding to current status of the contracts 204 and the obligations 206. The current status of an obligation may require certain procedures to be completed by a user; the triggering module 224 activates actions resulting in completion of the requisite procedures. For example, if the current status of an obligation is due, requiring a user to upload a document on a website, then the triggering module 224 sends timely reminders to the concerned user requesting for uploading the obligatory document. The triggered actions include sending e-mails, reminders, alerts, escalations, status modification requests, and so on.

Moreover, the method 300 may include generating reports or graphs at any point of time to understand status of a contract or a group of contracts.

FIG. 4 depicts an exemplary embodiment of a screenshot 400 of an obligation management system. The screenshot 400 illustrates details of an account that represents all contracts and obligations entered with a particular organization. The left side of the screen shows the tree structure representing the contracts assembled in a hierarchical manner, and the corresponding metadata is shown towards the right side of the screen shot. The present disclosure provides a fully customizable system, enabling the user to modify the view based on business requirements or user's selection. It should be understood that the screenshot 400 is an exemplary embodiment, and the visual formats to depict data may vary based on user's preference.

Those skilled in the art will understand that the steps set out in the discussion above may be combined or altered in specific adaptations of the disclosure. The illustrated steps are set out to explain the embodiment shown, and it should be anticipated that ongoing technological development would change the manner in which particular functions are performed. These depictions do not limit the scope of the disclosure, which is determined solely by reference to the appended claims.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An obligation management system, comprising:
a database storage system including at least one contract, wherein the contract includes a plurality of obligations; and
a data processing system operatively coupled to the database storage systems, the data processing system is configured to:
extract the plurality of obligations associated with the contract from the database storage system;
define relationships between the plurality of obligations;
compute the relationships; and
trigger actions based on the computation.

2. The obligation management system of claim 1, wherein the data processing system is configured to extract the plurality of obligations and associated metadata.

3. The obligation management system of claim 2, wherein the data processing system is further configured to assemble the plurality of obligations in a hierarchical structure, based on the associated metadata.

4. The obligation management system of claim 1, wherein the data processing system is configured to assign a set of parameters to each obligation from the plurality of obligations.

5. The obligation management system of claim 4, wherein the set of parameters includes one or more of:
current status,
due date, or
reoccurrence frequency.

6. The obligation management system of claim 4, wherein the data processing system is configured to define relationships between the plurality of obligations using the sets of parameters.

7. The obligation management system of claim 4, wherein the data processing system is configured to compute the relationships, based on a determination that the value of at least one parameter from the set of parameters changes.

8. The obligation management system of claim 1, wherein the data processing system is further configured to redefine relationships upon addition, modification, or deletion of at least one obligation from the plurality of obligations.

9. The obligation management system of claim 4, wherein the data processing system is configured to trigger actions corresponding to an obligation based on the current value of the associated set of parameters.

10. The obligation management system of claim 1, wherein the actions include one or more of:
notifications,
escalations,
reminders,
report generation, or
status modification.

11. The obligation management system of claim 2, wherein the database storage system is searchable using keywords and metadata.

12. The obligation management system of claim 1, wherein the data processing system is further configured to generate reports.

13. The obligation management system of claim 1 further including a security module providing access controls to users.

14. A system for automatically managing obligations, the system comprising:
a database storage system including a set of contracts, wherein each contract includes a plurality of obligations; and
a data processing system operatively coupled to the database storage systems, the data processing system is configured to:
extract the set of contracts, the corresponding obligations, and associated metadata;
assemble the contracts and the corresponding obligations in a hierarchical structure, based on the associated metadata;
assign a set of parameters to each contract and obligation from the set of contracts and the obligations;
define relationships between the contracts and the plurality of obligations using the set of parameters;
compute the relationships, wherein a relationship is computed once the value of at least one parameter from the set of parameters changes; and
trigger actions based on the computation, actions being based on the current values of the set of parameters associated with the contracts and the plurality of obligations.

15. The system of claim 14, wherein the set of parameters include one or more of:
current status,
due date, or
reoccurrence frequency.

16. The system of claim 14, wherein the triggered actions include one or more of:
notifications,
escalations,
reminders,
reports, or
status modification.

17. The system of claim 14, wherein the extracted contracts and obligations are searchable using keywords and metadata.

18. The system of claim 14, wherein the data processing system is further configured to redefine relationships upon addition, modification, or deletion of at least one obligation from the plurality of obligations.

19. A method for automating obligation compliance management, the method comprising:
receiving a set of contracts, corresponding plurality of obligations, and associated metadata;
assembling the contracts and the plurality of obligations in a hierarchical structure, using the associated metadata;
assigning a set of parameters to each contract and obligation from the set of contracts and the plurality of obligations;
defining relationships between the contracts and the plurality of obligations, using the set of parameters;
computing the relationships, based on a determination that the value of at least one parameter from the set of parameter is modified; and
triggering actions based on the computations, actions being based on the current values of the set of parameters.

20. The method of claim 19 further including generating reports.
